(19) United States
(12) Patent Application Publication
(10) Pub. No.: US 2006/0147826 A1
(43) Pub. Date: Jul. 6, 2006

(54) Undercoat layer and method of forming the same and photoconductor comprising undercoat layer

(75) Inventors: Chien-Chung Bi, Hsinchu County (TW); Chen-Jen Yang, Hsinchu City (TW)

Correspondence Address: BIRCH STEWART KOLASCH & BIRCH, PO BOX 747, FALLS CHURCH, VA, 22040-0747, US

(73) Assignee: SINONAR Corp.

(21) Appl. No.: 11/211,498

(22) Filed: Aug. 26, 2005

(30) Foreign Application Priority Data
Jan. 5, 2005 (TW) 94100238

(51) Int. Cl. G03G 5/14

(52) U.S. Cl. 430/64; 430/131; 430/60

(57) ABSTRACT

An undercoat layer for photoconductor. The undercoat layer includes a resin and a plurality of powders dispersed therein. The powders include a first powder and at least one of a second and a third powders. The first powder is an inorganic powder covered by a conductive layer, the second powder is a silicon dioxide powder modified by siloxane, and the third powder is a hybrid powder of siloxane.

### BACKGROUND

The present invention relates to a photoconductor, and more specifically to a photoconductor comprising a novel undercoat layer.

Generally, photoconductors are used in laser printers or photostats to capture, transfer, and generate patterns. Printing processes of a laser printer are illustrated as follows.

Laser printing processes comprising charging, exposure, development, transfer, fusing, cleaning, and erasure are performed continuously and repeatedly until printing is completed.

When a command is issued via an application to a laser printer, negative or positive charges are immediately distributed over a photoconductor thereof such as organic photoconductor (OPC) or OPC drum. Image patterns are then projected to the photoconductor through laser and exposed. When the fast rolling photoconductor passes through a toner cartridge, the exposed region absorbs toners to develop the image due to less electrostatic expulsion compared to the non-exposed region. Next, paper is fed into the printer and provided with a charge opposite to that of the toners. The toner image on the photoconductor is then transferred to and fused on the paper through high temperature and pressure process. Remaining toners on the photoconductor are removed by a scraper, after which the potential of the photoconductor surface returns to the initial state, in preparation for the next cycle.

During printing, all operations are based on the photoconductor, significantly affecting printer quality.

A photoconductor base structure 100 is illustrated in FIG. 1. The photoconductor 100 comprises an aluminum substrate 110, an undercoat layer (UCL) 120, a blocking layer (BL) 130, a charge generation layer (CGL) 140, a charge transfer layer (CTL) 150, and a protective layer (PL) 160. After the top of the multi-layer photoconductor 100 is irradiated by laser, electron/hole pairs 146 are formed in the charge generation layer 140. Electron/hole pairs 146, however, have different flow directions. Electrons 144 flow toward the substrate 110 and holes 142 flow toward the top of the multi-layer photoconductor 100 through the charge transfer layer 150.

An undercoat layer can be replaced by an anodized film combined with aluminum substrate. Such products, however, are more costly than those with an undercoat layer. Common aluminum substrate surface is rough, with defects and higher reflection, decreasing resolution. Thus, an undercoat layer is required to shade the substrate surface defects and reduce reflection and roughness negatively affecting print quality.

Generally, an undercoat layer comprises resin for adhesion, solvent to dissolve resin and adjust viscosity, powder to shade aluminum substrate defects and reduce laser reflection, and conductive substance to transfer electrons. Undercoat layer fabrication usually suffers from problems such as non-uniform powder dispersion or deteriorated print quality. U.S. Pat. No. 6,759,174 discloses use of an organic solvent having a specific boiling point and viscosity to improve powder dispersion. To improve print quality, U.S. Pat. No. 4,579,801 discloses combination of phenol formaldehyde resin and conductive powders as an undercoat layer. U.S. Pat. No. 5,017,449 discloses use of a specific nylon resin as an undercoat layer to improve electric properties of a photoconductor. U.S. Pat. No. 5,432,034 discloses use of copolymers as an undercoat layer. U.S. Pat. No. 5,556,728 discloses use of melamine and aromatic compounds containing carboxyl groups as an undercoat layer. U.S. Pat. No. 5,532,093 discloses addition of a blocking layer containing nickel. U.S. Pat. No. 5,744,271 discloses combination of treated TiO₂ and polyamide/butyl melamine to improve print quality. U.S. Pat. No. 6,017,664 discloses use of conductive polymers/alkali metal, resin, and inorganic pigment to reduce environmental affects on print quality. U.S. Pat. No. 5,391,448 discloses combination of non-conductive TiO₂ powders and polyamide resin as an undercoat layer to improve print quality. U.S. Pat. No. 5,468,584 discloses addition of SnO powders containing phosphorous to reduce environmental affects on print quality.

Additionally, aluminum substrate surface defects which cannot be shaded completely and interference fringe also affect print quality. U.S. Pat. No. 4,518,669 discloses formation of a polyamide resin layer on an undercoat layer to shade substrate surface defects. U.S. Pat. No. 5,763,125 discloses addition of a conductive film comprising unsaturated polyester, epoxy, and fine conductive powders. U.S. Pat. No. 5,162,185 discloses oxidization of aluminum substrate with acid solution to form an anode film to inhibit interference fringe.

To increase conductivity of conductive substance, U.S. Pat. No. 4,954,406 discloses use of thermoplastic and thermosetting resins as an undercoat layer to obtain proper conductivity of a photoconductor. U.S. Pat. No. 5,484,694 discloses alteration of quantities of antimony added to SnO to optimize conductivity. U.S. Pat. No. 5,489,496 discloses control of quantities and the diameter/length ratio of acicular TiO₂ powders to obtain proper conductivity. U.S. Pat. No. 5,384,190 discloses use of carbon black and conductive powders to achieve required resistance of an undercoat layer, further overcoming environmental affects on print quality. If conductivity is extremely high, the charge acceptance voltage (CAV) applied by electrical corona or primary charge roller (PCR) may be inadequate. On the contrary, if conductivity is insufficient, residual voltage of photoconductor surface may thus be excessive.

Thus, there exists a strong need in the art for an undercoat layer having optimal powder dispersion and conductivity and sufficient shade effect.

### SUMMARY

The invention provides an undercoat layer for photoconductor comprising a resin and a plurality of powders dispersed therein. The powders comprise a first powder and at least one of a second and a third powders, wherein the first powder is an inorganic powder covered by a conductive layer, the second powder is a silicon dioxide powder modified by siloxane, and the third powder is a hybrid powder of siloxane.

The invention also provides a method of forming an undercoat layer for photoconductor. A solvent containing a resin is provided. A plurality of powders is dispersed in the solvent to form a solution. The powders comprise a first powder and at least one of a second and a third powders, wherein the first powder is an inorganic powder covered by a conductive layer, the second powder is a silicon dioxide powder modified by siloxane, and the third powder is a hybrid powder of siloxane. The solution is applied on a substrate to form an undercoat layer.

The invention further provides a photoconductor comprising a substrate, the disclosed undercoat layer thereon, and a charge generation layer or a charge transfer layer on the undercoat layer.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a cross section of a conventional photoconductor.

FIG. 2 is a cross section of a photoconductor of an embodiment of the invention.

FIG. 3 is a cross section of a powder structure of an embodiment of the invention.

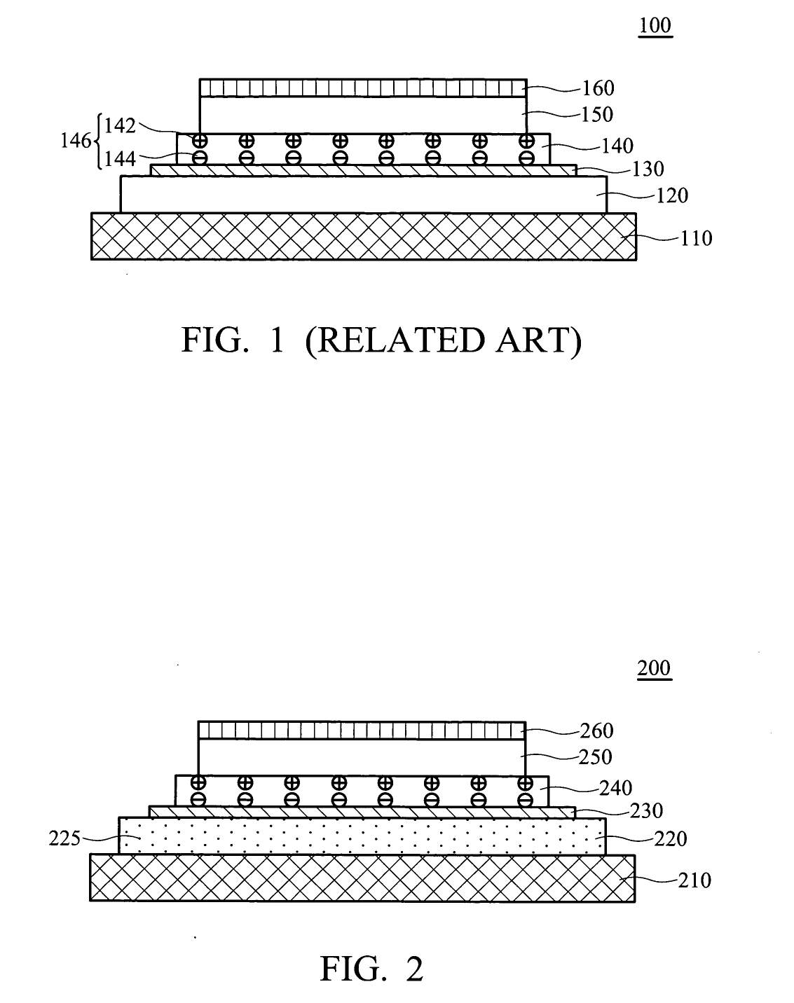

### DETAILED DESCRIPTION

The invention provides an undercoat layer for photoconductor comprising two or three different powders. Their chemical compositions and structures are disclosed as follows.

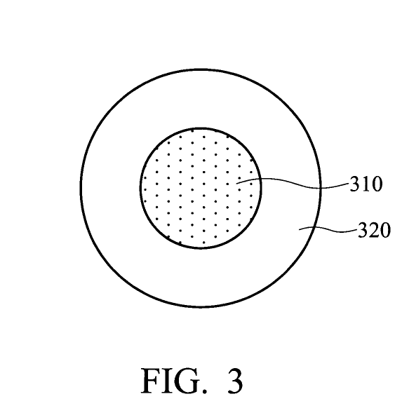

A first powder, such as an inorganic powder, covered by a conductive layer (not shown) is illustrated in FIG. 3. The powder comprises a core 310 comprising TiO₂, ZnO, BaSO₄, or carbon black powder and a shell 320. The conductive layer may comprise metal, metal oxide, or conductive polymers. The metal may be Sb, Cu, Au, Ag, Ni, or combinations thereof. The metal oxide may comprise SnO₂, indium tin oxide (ITO), antimony tin oxide (ATO), or combinations thereof. The conductive polymer may be polyaniline or polypyrrole. The first powder has a diameter of about 0.01˜50 μm.

A second powder may be a silicon dioxide powder modified by siloxane and has a diameter of about 0.01˜50 μm, preferably 0.1˜10 μm.

A third powder may be a hybrid powder of siloxane and has a diameter of about 0.01˜50 μm, preferably 0.1˜10 μm.

The powders provided by the invention can be mixed in three combinations such as the first and second powders, the first and third powders, or the first, second, and third powders. Various weight ratios thereof are disclosed as follows.

Mixing the first and second powders requires a weight ratio of about 1:100˜100:1, preferably 1:5˜5:1.

Mixing the first and third powders requires a weight ratio of about 1:100˜100:1, preferably 1:5˜5:1.

Mixing of the first, second, and third powders requires a weight ratio of the first powder to the second or third powder being about 1:100˜100:1, preferably 1:5˜5:1, and a weight ratio of the second powder to the third powder being about 1:20˜20:1, preferably 1:1.

The film comprising the second or third powders and conventional inorganic powders has improved light shade effect due to white powders, high refraction, and larger powder size. The second and third powders, however, can also be used individually or simultaneously to shield surface defects of a photoconductor substrate. Generally, laser scatter occurs when powder has a larger size than a laser spot. On the contrary, if powder is small, laser passes therethrough and irradiates to a metal substrate. Unfortunately, a quadratic image is formed after the metal substrate reflects laser, causing interference fringe, deteriorating print quality.

The first powder having an inorganic powder core and an opaque covered conductive layer provides an optimal light shade effect and modification to a photoconductor substrate, decreasing roughness and defects thereof.

Additionally, conductivity of an undercoat layer is controlled within a specific range due to the photoconductor which can generate and transfer charges. If conductivity is extremely high, the charge acceptance voltage (CAV) applied by electrical corona or primary charge roller (PCR) may be inadequate. On the contrary, if conductivity is insufficient, residual voltage of photoconductor surface may thus be excessive. Regardless of inadequate charge acceptance voltage or excessive residual voltage, it affects print quality. Thus, when only one powder or highly conductive powders are added, the original nature of the photoconductor may be lost. When the second/third powders and conductive powders are used, the sheet resistance of the undercoat layer is maintained within a range of about 10⁶˜10⁹ ohm/sqr, without inadequate charge acceptance voltage or excessive residual voltage.

Powders are often dispersed non-uniformly in an undercoat layer, deteriorating photoconductor quality. These three powders at sub-micrometer level and formed as hybrid can be dispersed uniformly therein, reducing hindrance of electron transmission and resistance.

Photoelectrical characteristics, such as sheet resistance, light shade effect, and electric properties, of the photoconductor are improved by addition of the functional powders.

The invention provides a method of forming an undercoat layer for photoconductor. A resin is dissolved in a solvent to form a solution. Powders are then dispersed in the solution. Finally, the solution is applied on a substrate to form an undercoat layer.

The disclosed method is merely one formation of the undercoat layer, and the invention is not limited thereto.

The resin is added to solvent with stirring and heating until completely dissolved. The resin may comprise polyester, polyamide, epoxy, or melamine. The solvent may be methanol or ethanol. Powders are dispersed in the solvent containing the resin to form a solution. The powders and the resin have a weight ratio of about 1:100˜1:1, preferably 1:50˜1:2. The solution is then applied on a substrate, such as aluminum substrate, to form an undercoat layer by such as dipping.

The photoconductor structure is illustrated in FIG. 2. An undercoat layer 220 is formed on a substrate 210. A blocking layer 230 comprising such as polyamide resin, a charge generation layer 240 comprising such as TiOPc, a charge transfer layer 250 comprising such as hydrazone, and a protective layer 260 comprising such as phenolic resin, are then formed on the undercoat layer 220 in order.

### EXAMPES

### Example 1

Preparation of Undercoat Solution

Composition ratios of the undercoat solution are shown in Table 1.

TABLE 1

| | | | | | Functional powders | | |
|---|---|---|---|---|---|---|---|
| | | | | | | Second | |
| | | | | | First | powders: | |
| | | | | | powders: | silicon | Third |
| | | | | | inorganic | dioxide | powders: |
| | | | | | powders | powders | hybrid |
| Undercoat | | | Resin | | covered by | modified | powders |
| solution | Solvent | | | Polyamide | conductive | by | of |
| Composition | Methanol | Butanol | Polyester | (CM8000) | layer | siloxane | siloxane |
| ratio | 16 | 16 | 1 | 4 | 1 | 1 | 1 |

Polyester (VYLON 220), polyamide (CM8000), methanol, and butanol were mixed according to the disclosed ratios, stirred, and heated to 60° C. until completely dissolved. First powders were then added and dispersed by a sand mill at 30° C. for 6 hours. Next, second and third powders were added and dispersed for 4 hours to form an undercoat solution.

The first powders (ET500W, Ishihara Techno Corp.) had a core of TiO₂, a shell of Sb and SnO₂, and a diameter of 200-300 nm.

The second powders were white and had a diameter of 800 nm.

The third powders were white and had a diameter of 2 μm.

Fabrication of Photoconductor

An undercoat layer with a thickness of 3˜5 μm, a charge generation layer with a thickness of 0.5 μm, and a charge transfer layer with a thickness of 20 μm were formed in order on a columnar aluminum substrate by dipping. The undercoat layer was baked at 120° C. for 1 hour. The charge generation layer was baked at 80° C. for 30 min. The charge transfer layer was baked at 150° C. for 1 hour. The aluminum substrate had a diameter of 30 mm and a length of 260.5 mm.

Property Measurement of Undercoat Layer and Photoconductor and Print Quality Test

Resistance measurement of undercoat layer: an undercoat layer was applied to form a rectangular film of 4 cm×4 cm and 15 μm thick. After drying, the film was measured at four measurement points with a probe. An average measurement result is shown in Table 12.

Electric property measurement of photoconductor: these properties were measured by a photo-induced discharge curve (PIDC) method. A negative voltage of −690 (V₀) was applied to photoconductor surface by electrical corona for 2 sec under light shade to achieve a dark development potential (V_{ddp}) thereof. The photoconductor surface was then exposed by a halogen light source at 780 nm and 2 μJ/cm² energy density for 2 sec to form a residual potential (Vr) thereof. Another measurement parameter, half-exposure energy (E_{1/2}), is defined as a required light energy which reduces V_{ddp} to half. Lower E_{1/2} exhibits higher light sensitivity. The measurement results are shown in Table 13.

Print quality test at room temperature and normal humidity: a HP-4300 commercial laser printer (45 pages/min) printed at 25° C. and 55% of relative humidity. Common drawbacks during printing such as ghosting, density, interference fringe, and resolution were compared, as shown in Table 14.

### Example 2

This example is similar to example 1. The distinction therebetween is powder ratio, as shown in Table 2.

TABLE 2

| | | | | | Functional powders | | |
|---|---|---|---|---|---|---|---|
| | | | | | | Second | |
| | | | | | First | powders: | |
| | | | | | powders: | silicon | Third |
| | | | | | inorganic | dioxide | powders: |
| | | | | | powders | powders | hybrid |
| Undercoat | | | Resin | | covered by | modified | powders |
| solution | Solvent | | | Polyamide | conductive | by | of |
| Composition | Methanol | Butanol | Polyester | (CM8000) | layer | siloxane | siloxane |
| ratio | 16 | 16 | 1 | 4 | 0 | 1 | 1 |

### Example 3

This example is similar to example 1. The distinction therebetween is powder ratio, as shown in Table 3.

TABLE 3

| | | | | | Functional powders | | |
|---|---|---|---|---|---|---|---|
| | | | | | | Second | |
| | | | | | First | powders: | |
| | | | | | powders: | silicon | Third |
| | | | | | inorganic | dioxide | powders: |
| | | | | | powders | powders | hybrid |
| Undercoat | | | Resin | | covered by | modified | powders |
| solution | Solvent | | | Polyamide | conductive | by | of |
| Composition | Methanol | Butanol | Polyester | (CM8000) | layer | siloxane | siloxane |
| ratio | 16 | 16 | 1 | 4 | 1 | 1 | 0 |

### Example 4

This example is similar to example 1. The distinction therebetween is powder ratio, as shown in Table 4.

TABLE 4

| | | | | | Functional powders | | |
|---|---|---|---|---|---|---|---|
| | | | | | | Second | |
| | | | | | First | powders: | |
| | | | | | powders: | silicon | Third |
| | | | | | inorganic | dioxide | powders: |
| | | | | | powders | powders | hybrid |
| Undercoat | | | Resin | | covered by | modified | powders |
| solution | Solvent | | | Polyamide | conductive | by | of |
| Composition | Methanol | Butanol | Polyester | (CM8000) | layer | siloxane | siloxane |
| ratio | 16 | 16 | 1 | 4 | 1 | 0 | 1 |

### Example 5

This example is similar to example 1. The distinction therebetween is powder ratio, as shown in Table 5.

TABLE 5

| | | | | | Functional powders | | |
|---|---|---|---|---|---|---|---|
| | | | | | | Second | |
| | | | | | First | powders: | |
| | | | | | powders: | silicon | Third |
| | | | | | inorganic | dioxide | powders: |
| | | | | | powders | powders | hybrid |
| Undercoat | | | Resin | | covered by | modified | powders |
| solution | Solvent | | | Polyamide | conductive | by | of |
| Composition | Methanol | Butanol | Polyester | (CM8000) | layer | siloxane | siloxane |
| ratio | 16 | 16 | 1 | 4 | 0 | 1 | 0 |

### Example 6

This example is similar to example 1. The distinction therebetween is powder ratio, as shown in Table 6.

TABLE 6

| | | | | | Functional powders | | |
|---|---|---|---|---|---|---|---|
| | | | | | | Second | |
| | | | | | First | powders: | |
| | | | | | powders: | silicon | Third |
| | | | | | inorganic | dioxide | powders: |
| | | | | | powders | powders | hybrid |
| Undercoat | | | Resin | | covered by | modified | powders |
| solution | Solvent | | | Polyamide | conductive | by | of |
| Composition | Methanol | Butanol | Polyester | (CM8000) | layer | siloxane | siloxane |
| ratio | 16 | 16 | 1 | 4 | 0 | 0 | 1 |

### Example 7

This example is similar to example 1. The distinction therebetween is first powder composition. The new first powders (Eeonomer500F, Eeonyx Corporation) had a core of carbon black, a shell of polyaniline, and a diameter of 40 nm.

### Example 8

This example is similar to example 1. The distinction therebetween is first powder composition. The new first powders (Eeonomer3002, Eeonyx Corporation) had a core of carbon black, a shell of polypyrrole, and a diameter of 200 nm.

### Example 9

This example is similar to example 1. The distinction therebetween is resin. The original polyester resin was replaced by epoxy (NPEL-128E, Nan Ya Plastic Corporation).

### Example 10

This example is similar to example 1. The distinction therebetween is resin. The original polyester resin was replaced by melamine (RESIMENE, Solutia Corp.).

### Example 11

This example is similar to example 4. The distinction therebetween is the third powder size. The new third powder diameter was 5 μm (MSP-K050, NIKKO RICA Corp.).

### Example 12

This example is similar to example 1. The distinction therebetween is the third powder size. The new third powder diameter was 13 μm (MSP-350, NIKKO RICA Corp.).

### Example 13

This example is similar to example 1. The distinction therebetween is resin ratio, as shown in Table 7.

TABLE 7

| | | | | | Functional powders | | |
|---|---|---|---|---|---|---|---|
| | | | | | | Second | |
| | | | | | First | powders: | |
| | | | | | powders: | silicon | Third |
| | | | | | inorganic | dioxide | powders: |
| | | | | | powders | powders | hybrid |
| Undercoat | | | Resin | | covered by | modified | powders |
| solution | Solvent | | | Polyamide | conductive | by | of |
| Composition | Methanol | Butanol | Polyester | (CM8000) | layer | siloxane | siloxane |
| ratio | 16 | 16 | 2 | 8 | 1 | 1 | 1 |

### Example 14

This example is similar to example 13. The distinction therebetween is powder ratio, as shown in Table 8.

TABLE 8

| | | | | | Functional powders | | |
|---|---|---|---|---|---|---|---|
| | | | | | | Second | |
| | | | | | First | powders: | |
| | | | | | powders: | silicon | Third |
| | | | | | inorganic | dioxide | powders: |
| | | | | | powders | powders | hybrid |
| Undercoat | | | Resin | | covered by | modified | powders |
| solution | Solvent | | | Polyamide | conductive | by | of |
| Composition | Methanol | Butanol | Polyester | (CM8000) | layer | siloxane | siloxane |
| ratio | 16 | 16 | 2 | 8 | 1 | 2.5 | 2.5 |

### Example 15

This example is similar to example 13. The distinction therebetween is powder ratio, as shown in Table 9.

TABLE 9

| | | | | | Functional powders | | |
|---|---|---|---|---|---|---|---|
| | | | | | | Second | |
| | | | | | First | powders: | |
| | | | | | powders: | silicon | Third |
| | | | | | inorganic | dioxide | powders: |
| | | | | | powders | powders | hybrid |
| Undercoat | | | Resin | | covered by | modified | powders |
| solution | Solvent | | | Polyamide | conductive | by | of |
| Composition | Methanol | Butanol | Polyester | (CM8000) | layer | siloxane | siloxane |
| ratio | 16 | 16 | 2 | 8 | 0.5 | 0 | 2 |

### Example 16

This example is similar to example 13. The distinction therebetween is powder ratio, as shown in Table 10.

TABLE 10

| | | | | | Functional powders | | |
|---|---|---|---|---|---|---|---|
| | | | | | | Second | |
| | | | | | First | powders: | |
| | | | | | powders: | silicon | Third |
| | | | | | inorganic | dioxide | powders: |
| | | | | | powders | powders | hybrid |
| Undercoat | | | Resin | | covered by | modified | powders |
| solution | Solvent | | | Polyamide | conductive | by | of |
| Composition | Methanol | Butanol | Polyester | (CM8000) | layer | siloxane | siloxane |
| ratio | 16 | 16 | 2 | 8 | 0.1 | 4 | 0 |

### Comparative Example 1

Preparation of Undercoat Solution

Composition ratios of the undercoat solution are shown in Table 11.

TABLE 11

| | | | | | Functional |
|---|---|---|---|---|---|
| | | | | | powders |
| | | | | | First |
| | | | | | powders: |
| | | | | | inorganic |
| | | | | | powders |
| Undercoat | | | Resin | | covered by |
| solution | Solvent | | | Polyamide | conductive |
| Composition | Methanol | Butanol | Polyester | (CM8000) | layer |
| ratio | 16 | 16 | 1 | 4 | 1 |

Polyester, polyamide (CM8000), methanol, and butanol were mixed according to the disclosed ratios, stirred, and heated to 60° C. until dissolved completely. First powders were then added and dispersed by a sand mill at 30° C. for 6 hours to form an undercoat solution.

The first powders (ET500W, Ishihara Techno Corp.) had a core of TiO₂, a shell of Sb and SnO₂, and a diameter of 200˜300 nm.

Additionally, photoconductor fabrication, property measurement of photoconductor and undercoat layer, and print quality test are similar to example 1.

### Comparative Example 2

This example is similar to comparative example 1. The distinction therebetween is first powder composition. The new first powders (Eeonomer500F, Eeonyx Corporation) had a core of carbon black, a shell of polyaniline, and a diameter of 40 nm.

### Comparative Example 3

This example is similar to comparative example 1. The distinction therebetween is first powder composition. The new first powders (FT1000, Ishihara Techno Corp.) had a core of TiO₂, a shell of Sb and SnO₂, a diameter of 0.13, and length of 1.68 μm.

### Comparative Example 4

This example is similar to comparative example 1. The distinction therebetween is first powder composition. The new first powders (Eeonomer3002, Eeonyx Corporation) had a core of carbon black, a shell of polypyrrole, and a diameter of 200 nm.

Results

Resistance of Undercoat Layer

TABLE 12

| Sample | Resistance (ohm/sqr.) |
|---|---|
| Example 1 | 3.4 × 10⁷ |
| Example 2 | 2.5 × 10⁷ |
| Example 3 | 1.8 × 10⁷ |
| Example 4 | 3.3 × 10⁷ |
| Example 5 | 1.1 × 10⁸ |
| Example 6 | 2.8 × 10⁸ |
| Example 7 | 1.5 × 10⁷ |
| Example 8 | 6.6 × 10⁷ |
| Example 9 | 7.8 × 10⁷ |
| Example 10 | 1.35 × 10⁸ |
| Example 11 | 4.8 × 10⁷ |
| Example 12 | 4.4 × 10⁷ |
| Example 13 | 3.3 × 10⁷ |
| Example 14 | 2.56 × 10⁷ |
| Example 15 | 2.54 × 10⁷ |
| Example 16 | 6.89 × 10⁷ |
| Comparative example 1 | 6.55 × 10⁷ |
| Comparative example 2 | 9.0 × 10⁷ |
| Comparative example 3 | 2.56 × 10⁸ |
| Comparative example 4 | 6.6 × 10⁷ |
| Blank aluminum substrate | 1.4 × 10⁹ |
| (anode film) | |
| Blank aluminum substrate | 1.7 × 10⁸ |
| (without anode film) | |

The ideal resistance range of photoconductor is about 10⁶˜10⁹ ohm/sqr. The results indicate that the blank aluminum substrate with an anode film has a larger resistance than that without anode film and all examples and comparative examples have reasonable resistance.

Electric Property of Photoconductor

TABLE 13

| | Initial | Residual | |
|---|---|---|---|
| | charging | potential | |
| Sample | voltage (V₀) | (Vr) | E_{1/2} |
| Example 1 | 700 | 30 | 0.098 |
| Example 2 | 710 | 40 | 0.11 |
| Example 3 | 700 | 30 | 0.099 |
| Example 4 | 700 | 30 | 0.099 |
| Example 5 | 712 | 50 | 0.11 |
| Example 6 | 715 | 50 | 0.111 |
| Example 7 | 700 | 30 | 0.099 |
| Example 8 | 701 | 30 | 0.1 |
| Example 9 | 705 | 32 | 0.1 |
| Example 10 | 710 | 55 | 0.12 |
| Example 11 | 701 | 35 | 0.1 |
| Example 12 | 703 | 36 | 0.1 |
| Example 13 | 720 | 35 | 0.1 |
| Example 14 | 700 | 35 | 0.1 |
| Example 15 | 710 | 36 | 0.1 |
| Example 16 | 703 | 30 | 0.1 |
| Comparative | 700 | 32 | 0.099 |
| example 1 | | | |
| Comparative | 702 | 32 | 0.1 |
| example 2 | | | |
| Comparative | 700 | 50 | 0.1 |
| example 3 | | | |
| Comparative | 701 | 32 | 0.1 |
| example 4 | | | |

If the initial or measurement data (V₀, Vr, or E_{1/2}) is abnormal, printing defects occur. For example, low V₀ causes residual dust on media, high Vr generates ghosting, and large E_{1/2} negatively affects density and resolution. The desirable data are determined by selection of proper photoconductor materials.

Compared to Table 13, 14, and 15, interference fringe appears during printing and becomes more serious after printing ten thousand pages in comparative examples 1˜4 due to extremely small powders, even light sensitivity achieves 0.099˜0.1.

See Table 14 and 15, wherein resolution is worse at initial printing and becomes more serious after printing ten thousand pages in comparative examples 2˜4. In comparative example 1, resolution becomes worse after printing ten thousand pages due to lack of hybrid powders of siloxane or silicon dioxide powders modified by siloxane.

In all examples and comparative examples, photoconductor provides better sensitivity (E_{1/2}) less than 0.12 and density more than 1.3.

In example 5 (only second powders added), example 6 (only third powders added), example 10 (polyester is replaced by melamine), and comparative example 3 (bar first powders added), residual potential (Vr) is extremely large equal to 50 or greater, resulting in ghosting at initial printing or after printing ten thousand pages.

Print quality tests at room temperature (25° C.) and normal humidity (relative humidity 55%) are shown in Table 14 and 15.

TABLE 14

| Printing | | | Interference | |
|---|---|---|---|---|
| first page | Ghosting | Density | fringe | Resolution |
| Example 1 | No | 1.44 | No | Good |
| Example 2 | No | 1.39 | No | Good |
| Example 3 | No | 1.4 | No | Good |
| Example 4 | No | 1.4 | No | Good |
| Example 5 | Light | 1.38 | No | Good |
| Example 6 | Light | 1.38 | No | Good |
| Example 7 | No | 1.35 | No | Good |
| Example 8 | No | 1.35 | No | Good |
| Example 9 | No | 1.33 | No | Good |
| Example 10 | Light | 1.33 | No | Good |
| Example 11 | No | 1.39 | No | Good |
| Example 12 | No | 1.39 | No | Good |
| Example 13 | No | 1.4 | No | Good |
| Example 14 | No | 1.4 | No | Good |
| Example 15 | No | 1.4 | No | Good |
| Example 16 | No | 1.4 | No | Good |
| Comparative | No | 1.39 | Light | Good |
| example 1 | | | | |
| Comparative | No | 1.32 | Serious | Worse |
| example 2 | | | | |
| Comparative | Light | 1.32 | Serious | Worse |
| example 3 | | | | |
| Comparative | No | 1.35 | serious | Worse |
| example 4 | | | | |

TABLE 15

| After | | | | |
|---|---|---|---|---|
| printing | | | | |
| ten | | | | |
| thousand | | | Interference | |
| pages | Ghosting | Density | fringe | Resolution |
| Example 1 | No | 1.46 | No | Good |
| Example 2 | No | 1.4 | No | Good |
| Example 3 | No | 1.4 | No | Good |
| Example 4 | No | 1.41 | No | Good |
| Example 5 | Light | 1.39 | No | Good |
| Example 6 | Light | 1.38 | No | Good |
| Example 7 | No | 1.36 | No | Good |
| Example 8 | No | 1.36 | No | Good |
| Example 9 | No | 1.36 | No | Good |
| Example 10 | Light | 1.36 | No | Good |
| Example 11 | No | 1.39 | No | Good |
| Example 12 | No | 1.4 | No | Good |
| Example 13 | No | 1.41 | No | Good |
| Example 14 | No | 1.41 | No | Good |
| Example 15 | No | 1.41 | No | Good |
| Example 16 | No | 1.41 | No | Good |
| Comparative | No | 1.3 | serious | Worse |
| example 1 | | | | |
| Comparative | No | 1.3 | Serious | Extremely |
| example 2 | | | | worse |
| Comparative | serious | 1.3 | Serious | Extremely |
| example 3 | | | | worse |
| Comparative | No | 1.3 | serious | Extremely |
| example 4 | | | | worse |

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An undercoat layer for photoconductor, comprising:
a resin; and
a plurality of powders dispersed therein comprising a first powder and at least one of a second and third powders, wherein the first powder is an inorganic powder covered by a conductive layer, the second powder is a silicon dioxide powder modified by siloxane, and the third powder is a hybrid powder of siloxane.

2. The undercoat layer for photoconductor as claimed in claim 1, wherein the conductive layer is metal, metal oxide, or conductive polymer.

3. The undercoat layer for photoconductor as claimed in claim 2, wherein the metal comprises Sb, Cu, Au, Ag, Ni, or combinations thereof.

4. The undercoat layer for photoconductor as claimed in claim 2, wherein the metal oxide comprises SnO₂, indium tin oxide (ITO), antimony tin oxide (ATO), or combinations thereof.

5. The undercoat layer for photoconductor as claimed in claim 2, wherein the conductive polymer comprises polyaniline or polypyrrole.

6. The undercoat layer for photoconductor as claimed in claim 1, wherein the inorganic powder comprises TiO₂, ZnO, or BaSO₄.

7. The undercoat layer for photoconductor as claimed in claim 1, wherein the first powder has a diameter of about 0.01˜50 μm.

8. The undercoat layer for photoconductor as claimed in claim 1, wherein the second powder has a diameter of about 0.01˜50 μm.

9. The undercoat layer for photoconductor as claimed in claim 1, wherein the third powder has a diameter of about 0.01˜50 μm.

10. The undercoat layer for photoconductor as claimed in claim 1, wherein the powders comprise the first and second powders, with a weight ratio of about 1:100˜100:1.

11. The undercoat layer for photoconductor as claimed in claim 1, wherein the powders comprise the first and third powders, with a weight ratio of about 1:100˜100:1.

12. A method of forming an undercoat layer for photoconductor, comprising:
providing a solvent;
dissolving a resin in the solvent;
dispersing a plurality of powders in the solvent containing the resin to form a solution, wherein the powders comprise a first powder and at least one of a second and a third powders, wherein the first powder is an inorganic powder covered by a conductive layer, the second powder is a silicon dioxide powder modified by siloxane, and the third powder is a hybrid powder of siloxane; and
applying the solution to a substrate to form an undercoat layer.

13. The method of forming an undercoat layer for photoconductor as claimed in claim 12, wherein the first powder has a diameter of about 0.01˜50 μm.

14. The method of forming an undercoat layer for photoconductor as claimed in claim 12, wherein the second powder has a diameter of about 0.01˜50 μm.

15. The method of forming an undercoat layer for photoconductor as claimed in claim 12, wherein the third powder has a diameter of about 0.01˜50 μm.

16. The method of forming an undercoat layer for photoconductor as claimed in claim 12, wherein the powders and the resin have a weight ratio of about 1:100˜1:1.

17. The method of forming an undercoat layer for photoconductor as claimed in claim 12, wherein the powders comprise the first and second powders, with a weight ratio of about 1:100˜100:1.

18. The method of forming an undercoat layer for photoconductor as claimed in claim 12, wherein the powders comprise the first and third powders, with a weight ratio of about 1:100˜100:1.

19. A photoconductor, comprising:
a substrate;
an undercoat layer of claim 1 on the substrate; and
a charge generation layer on the undercoat layer.

20. The photoconductor as claimed in claim 19, wherein the substrate is an aluminum substrate.

21. The photoconductor as claimed in claim 19, further comprising a blocking layer between the undercoat layer and the charge generation layer.

22. The photoconductor as claimed in claim 19, further comprising a charge transfer layer on the charge generation layer.

23. The photoconductor as claimed in claim 19, further comprising a protective layer on the charge generation layer.
